(19) United States
(12) Patent Application Publication
(10) Pub. No.: US 2023/0257596 A1
(43) Pub. Date: Aug. 17, 2023

(54) LIQUID PAINT PROTECTION FILMS AND METHODS OF MAKING AND USING SAME

(71) Applicant: Feynlab Inc., Lombard, IL (US)

(72) Inventors: John Suerth, Lombard, IL (US); Philip Coetzee, Lombard, IL (US)

(21) Appl. No.: 18/190,080

(22) Filed: Mar. 25, 2023

Related U.S. Application Data
(60) Provisional application No. 63/289,741, filed on Dec. 15, 2021.

(51) Int. Cl. C09D 5/26; C09D 5/00; C09D 5/02; C09D 153/00; C09D 133/14

(52) U.S. Cl. CPC C09D 5/26; C09D 5/002; C09D 5/021; C09D 133/14; C09D 153/00

(57) ABSTRACT

The present disclosure provides films (e.g., spray-applied films) for protecting surfaces, such as automobile panels, and methods of making and using same.

### PRIORITY CLAIM

This application claims priority to U.S. Provisional Pat. Application Serial No. 63/289,741, filed on Dec. 15, 2021, the entire contents of which are incorporated herein by reference and relied upon.

### FIELD OF THE INVENTION

The present disclosure provides films (e.g., spray-applied films) for protecting painted surfaces, such as painted automobile panels, and methods of making and using same.

### BACKGROUND

Protection of metal or polymer surfaces, such as automobile panels, from abrasion, scratches, weather, and other damage has challenged engineers since the first vehicles were produced. Paint protection films (PPF) are typically large sheets of polyurethane plastic with an adhesive layer (e.g., an acrylic adhesive) on one face and a topcoat layer on the opposite face. The sheets are typically cut to size and pressed over the panel surface to offer some protection and improve cleaning efficiencies. Installing PPF requires highly skilled labor and often teams of laborers. PPF is expensive, difficult to remove, and cannot be installed using spray techniques or using spray paint systems commonly preferred by automobile body technicians.

A need persists for peelable films for protecting substrates such as vehicle panels that can be efficiently and economically installed using standard spray paint equipment and techniques. The present disclosure provides technology that meets this need.

### SUMMARY

The present disclosure provides films (e.g., spray-applied films) for protecting painted surfaces, such as painted automobile panels, and methods of making and using same.

In some embodiments, the present disclosure provides a protective film comprising: a first layer disposed adjacent to a painted surface, the first layer comprising, consisting essentially of, or consisting of a flexible polymer; and an outer layer disposed opposite the painted surface, the top layer comprising, consisting essentially of, or consisting of a topcoat material.

In other embodiments, the present disclosure provides a spray-applied protective film product comprising: a spray-applied base layer component comprising, consisting essentially of, or consisting of a peelable polymer; and a spray-applied outer layer component comprising, consisting essentially of, or consisting of a self-healing polymer.

In still other embodiments, the present disclosure provides a method of forming a paint protective layer on a substrate, the method comprising: applying a first layer to the substrate, the first layer comprising, consisting essentially of, or consisting of a peelable polymer; and applying an outer layer to the first layer, the outer layer component comprising, consisting essentially of, or consisting of a self-healing polymer.

In other embodiments, the present disclosure provides a substrate comprising: a pre-existing paint layer adhered to a surface of the substrate; a first layer disposed adjacent to a painted surface, the first layer comprising, consisting essentially of, or consisting of a flexible polymer; and an outer layer disposed opposite the painted surface, the top layer comprising, consisting essentially of, or consisting of a topcoat material.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows a film (e.g., a multilayer film) consistent with the present disclosure after being applied (e.g., spray-applied) to a substrate.

FIG. 2 shows a film (e.g., a multilayer film) consistent with the present disclosure and comprising a plurality of layers of a peelable layer and a plurality of layers of a topcoat, after being applied (e.g., spray-applied) to a substrate.

FIG. 3 shows a film (e.g., a multilayer film) consistent with the present disclosure and including an optional color layer (e.g., base coat) disposed between the peelable layer and the topcoat layer, after being applied (e.g., spray-applied) to a substrate.

FIG. 4 shows a film (e.g., a multilayer film) consistent with the present disclosure and comprising a plurality of layers of a peelable layer, a plurality of layers of a topcoat, and a plurality of layers of an optional color layer (e.g., base coat), after being applied (e.g., spray-applied) to a substrate.

FIG. 5 shows a photograph of a film (e.g., a multilayer film) consistent with the present disclosure comprising a peelable layer, a color layer, and a topcoat layer being peeled away from a substrate.

### DETAILED DESCRIPTION

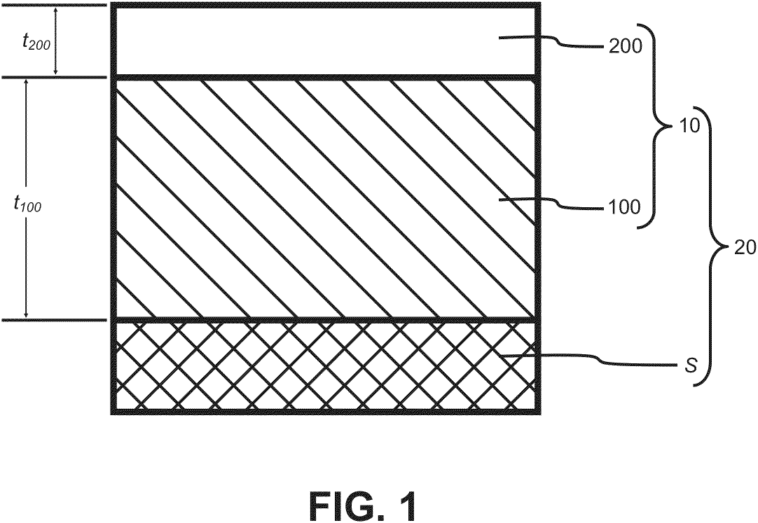

Referring generally to FIGS. 1-5, the present disclosure provides films (e.g., spray-applied films) for protecting painted surfaces, such as painted automobile panels, and methods of making and using same.

### Film Compositions

Generally, films 10 consistent with the present disclosure include a peelable layer 100 and a topcoat layer 200 disposed on a substrate S. The substrate S may be any surface for which protection might be desired, such as a painted surface like a painted automobile panel.

Films 10 consistent with the present disclosure may have an adhesion strength thirty days after installation (ASTM D3330, Method F) of about 1.5 N/cm to about 3.5 N/cm, or about 2 N/cm to about 3 N/cm. In some embodiments, the film 10 has an adhesion strength thirty days after installation of about 1.5 N/cm. In some embodiments, the film 10 has an adhesion strength thirty days after installation of about 1.6 N/cm. In some embodiments, the film 10 has an adhesion strength thirty days after installation of about 1.7 N/cm. In some embodiments, the film 10 has an adhesion strength thirty days after installation of about 1.8 N/cm. In some embodiments, the film 10 has an adhesion strength thirty days after installation of about 1.9 N/cm. In some embodiments, the film 10 has an adhesion strength thirty days after installation of about 2 N/cm. In some embodiments, the film 10 has an adhesion strength thirty days after installation of about 2.1 N/cm. In some embodiments, the film 10 has an adhesion strength thirty days after installation of about 2.2 N/cm. In some embodiments, the film 10 has an adhesion strength thirty days after installation of about 2.3 N/cm. In some embodiments, the film 10 has an adhesion strength thirty days after installation of about 2.4 N/cm. In some embodiments, the film 10 has an adhesion strength thirty days after installation of about 2.5 N/cm. In some embodiments, the film 10 has an adhesion strength thirty days after installation of about 2.6 N/cm. In some embodiments, the film 10 has an adhesion strength thirty days after installation of about 2.7 N/cm. In some embodiments, the film 10 has an adhesion strength thirty days after installation of about 2.8 N/cm. In some embodiments, the film 10 has an adhesion strength thirty days after installation of about 2.9 N/cm. In some embodiments, the film 10 has an adhesion strength thirty days after installation of about 3 N/cm. In some embodiments, the film 10 has an adhesion strength thirty days after installation of about 3.1 N/cm. In some embodiments, the film 10 has an adhesion strength thirty days after installation of about 3.2 N/cm. In some embodiments, the film 10 has an adhesion strength thirty days after installation of about 3.3 N/cm. In some embodiments, the film 10 has an adhesion strength thirty days after installation of about 3.4 N/cm. In some embodiments, the film 10 has an adhesion strength thirty days after installation of about 3.5 N/cm.

Films 10 consistent with the present disclosure generally have a gloss value at 60° (XQT 104 method) of at least about 80 GU, for example at least about 80 GU, at least about 81 GU, at least about 82 GU, at least about 83 GU, at least about 84 GU, at least about 85 GU, at least about 86 GU, at least about 87 GU, at least about 88 GU, at least about 89 GU, at least about 90 GU, at least about 91 GU, at least about 92 GU, at least about 93 GU, at least about 94 GU, or at least about 95 GU.

Films 10 consistent with the present disclosure generally have a UV resistance value after 1,000 hours of exposure (ASTM D4329 method) of at least about 80%, for example at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99%.

Films 10 consistent with the present disclosure generally display no substantial penetration or no penetration to stone chip resistance (gravelometer) testing under SAE J400 methods (3 pints of gravel at 70 psi and 45° impingement angle).

Films 10 consistent with the present disclosure generally have a total thickness (t₁₀₀ + t₂₀₀ + t₃₀₀) of about 200 microns to about 350 microns, or about 250 microns to about 300 microns.

In some embodiments, a film 10 consistent with the present disclosure has a total thickness (t₁₀₀ + t₂₀₀ + t₃₀₀) of about 250 microns to about 300 microns, displays no penetration to stone chip resistance (gravelometer) testing under SAE J400 methods (3 pints of gravel at 70 psi and 45° impingement angle), has a UV resistance value of at least about 90% after 1,000 hours of exposure (ASTM D4329 method), has a gloss value at 60° (XQT 104 method) of at least about 90 GU, and has an adhesion strength thirty days after installation (ASTM D3330, Method F) of about 2 N/cm to about 3 N/cm.

### A. Peelable Layers

The peelable layer 100 is disposed adjacent to (e.g., in contact with) a substrate S. Generally, the peelable layer 100 temporarily (e.g., semi-permanently) adheres to the substrate S (e.g., to an outermost surface, paint or coating layer of the substrate S). If the film 10 or a portion thereof needs to be replaced, the peelable layer 100 may be removed from the substrate S without causing damage to the substrate S or its outermost surface, paint layer, or coating.

The peelable layer 100 includes a flexible polymer. In some embodiments, the peelable layer 100 comprises a flexible polymer. In some embodiments, the peelable layer 100 consists essentially of a flexible polymer. In some embodiments, the peelable layer 100 consists of a flexible polymer.

The flexible polymer may, in some embodiments, the flexible polymer includes a copolymer. In some embodiments, the flexible polymer comprises a copolymer. In some embodiments, the flexible polymer consists essentially of a copolymer. In some embodiments, the flexible polymer consists of a copolymer.

The copolymer may, in some embodiments, comprise a copolymer of styrene and ethylene/butylene. In some embodiments, the copolymer consists essentially of a copolymer of styrene and ethylene/butylene. In some embodiments, the copolymer consists of a copolymer of styrene and ethylene/butylene. The styrene and ethylene/butylene monomeric units may be arranged in any suitable relative configuration. In some embodiments, the styrene and ethylene/butylene monomeric units are arranged in a linear configuration. In other embodiments, the styrene and ethylene/butylene monomeric units are arranged in a non-linear (e.g., branched) configuration. In some embodiments, the styrene and ethylene/butylene monomeric units are arranged in a random relative configuration. In other embodiments, the styrene and ethylene/butylene monomeric units are arranged in an alternating arrangement. In other embodiments, the styrene and ethylene/butylene monomeric units are arranged in a block copolymer configuration, such as a linear triblock copolymer configuration.

In some embodiments, the copolymer includes a polystyrene content of about 5% to about 35%, about 10% to about 30%, or about 15% to about 25%. In some embodiments, the copolymer includes a polystyrene content of about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, or about 35%.

The peelable layer 100 may have a thickness t₁₀₀ of about 150 microns to about 300 microns, about 190 microns to about 240 microns, or about 200 microns to about 230 microns. In some embodiments, the peelable layer 100 has a thickness t₁₀₀ of about 150 microns, about 160 microns, about 170 microns, about 180 microns, about 190 microns, about 200 microns, about 210 microns, about 220 microns, about 230 microns, about 240 microns, about 250 microns, about 260 microns, about 270 microns, about 280 microns, about 290 microns, or about 300 microns.

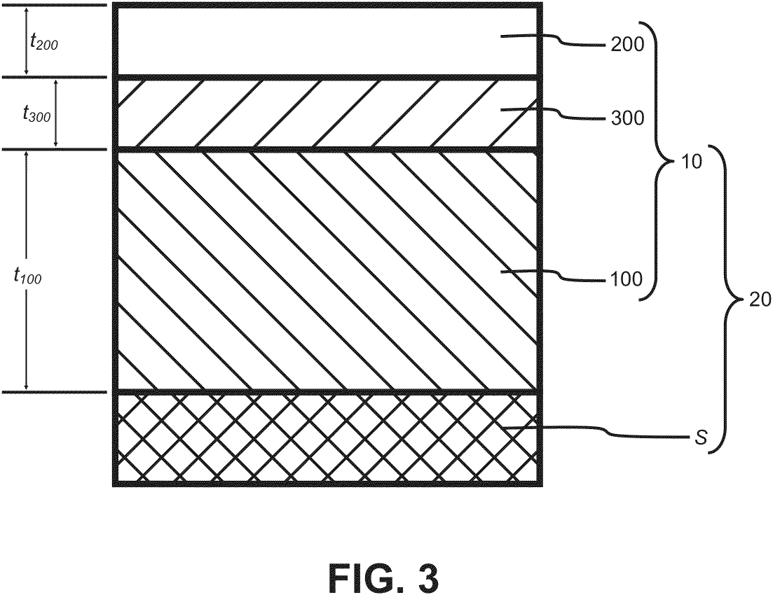

In some embodiments, the peelable layer 100 includes a single layer, such as shown representatively in cross-sectional format in FIGS. 1 and 3.

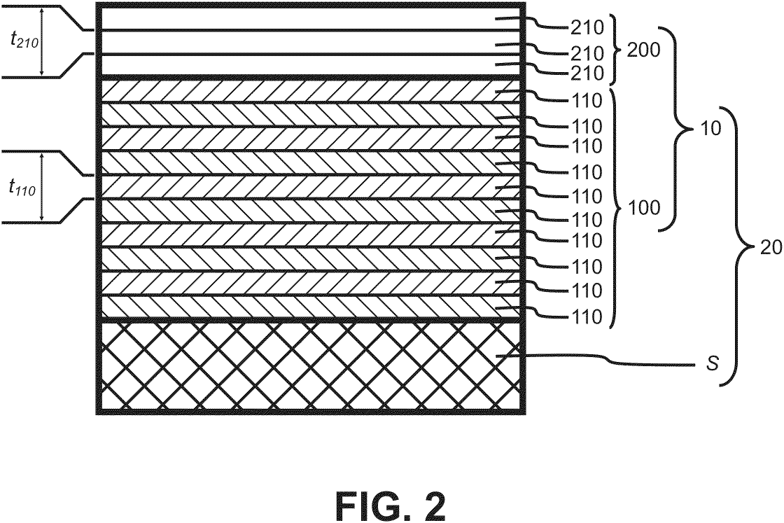

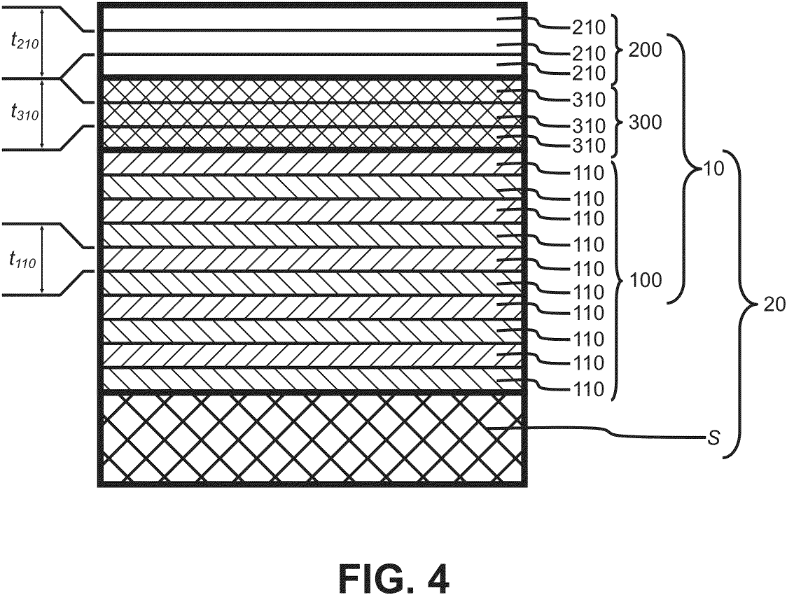

In other embodiments, such as those consistent with the cross-sectional views shown in FIGS. 2 and 4, the peelable layer 100 includes a plurality of layers 110. In some embodiments, the peelable layer 100 includes at least two layers 110, such as at least two layers 110, at least 3 layers 110, at least 4 layers 110, at least 5 layers 110, at least 6 layers 110, at least 7 layers 110, at least 8 layers 110, at least 9 layers 110, at least 10 layers 110, or more than 10 layers 110. Each layer 110 may have a thickness t₁₁₀ of about 15 microns to about 30 microns, about 19 microns to about 24 microns, or about 20 microns to about 23 microns. In some embodiments, each layer 110 has a thickness t₁₁₀ of about 15 microns, about 16 microns, about 17 microns, about 18 microns, about 19 microns, about 20 microns, about 21 microns, about 22 microns, about 23 microns, about 24 microns, about 25 microns, about 26 microns, about 27 microns, about 28 microns, about 29 microns, or about 30 microns.

### B. Topcoat Layers

The topcoat layer 200 is the outermost layer of the film and is generally optically clear. In some embodiments, the topcoat layer 200 is a self-healing layer. In other embodiments, the self-healing layer is an autonomously self-healing layer (e.g., requires no substantial input or no input of energy, such as heat, from an applied energy source).

The topcoat layer 200 may have a thickness t₂₀₀ of about 40 microns to about 120 microns, about 50 microns to about 100 microns, or about 60 microns to about 80 microns. In some embodiments, the topcoat layer 200 has a thickness t₂₀₀of about 40 microns, about 50 microns, about 60 microns, about 70 microns, about 80 microns, about 90 microns, about 100 microns, about 110 microns, about 120 microns, about 130 microns, about 140 microns, about 150 microns, about 160 microns, about 170 microns, about 180 microns, about 190 microns, or about 200 microns.

In some embodiments, the topcoat layer 200 includes a single layer, such as shown representatively in cross-sectional format in FIGS. 1 and 3.

In other embodiments, such as those consistent with the cross-sectional views shown in FIGS. 2 and 4, the topcoat layer 200 includes a plurality of layers 210. In some embodiments, the topcoat layer 200 includes at least two layers 210, such as at least two layers 210, at least 3 layers 210, at least 4 layers 210, at least 5 layers 210, at least 6 layers 210, at least 7 layers 210, at least 8 layers 210, at least 9 layers 210, at least 10 layers 210, or more than 10 layers 210. Each layer 210 may have a thickness t₂₁₀ of about 8 microns to about 30 microns, about 10 microns to about 25 microns, or about 12 microns to about 20 microns. In some embodiments, each layer 210 has a thickness t₂₁₀ of about 8 microns, about 9 microns, about 10 microns, about 11 microns, about 12 microns, about 13 microns, about 14 microns, about 15 microns, about 16 microns, about 17 microns, about 18 microns, about 19 microns, about 20 microns, about 21 microns, about 22 microns, about 23 microns, about 24 microns, about 25 microns, about 26 microns, about 27 microns, about 28 microns, about 29 microns, or about 30 microns.

In some embodiments, the topcoat layer 200 is a self-healing layer. The self-healing layer 200 heals marring, or scratches that occur through a portion of the thickness t₂₀₀ of the topcoat layer 200. In some embodiments, the self-healing layer 200 autonomously heals (e.g., reverses) marring or scratches without contacting the topcoat layer 200 with energy, such as heat, from an energy source. In some such embodiments, the self-healing layer 200 autonomously heals (e.g., reverses) marring or scratches at ambient temperature.

In such embodiments, the self-healing layer may include a hydroxyl functional acrylic resin. In some embodiments, the self-healing topcoat layer comprises a hydroxyl functional acrylic resin. In some embodiments, the self-healing topcoat layer consists essentially of a hydroxyl functional acrylic resin. In some embodiments, the self-healing topcoat layer consists of a hydroxyl functional acrylic resin.

The hydroxyl functional acrylic resin may be any suitable hydroxyl functional acrylic resin. In some embodiments, the hydroxyl functional acrylic resin has a hydroxyl value on solution of about 50 mg KOH/g to about 120 mg KOH/g, about 60 mg KOH/g to about 110 mg KOH/g, about 70 mg KOH/g to about 100 mg KOH/g, or about 80 to about 90 mg KOH/g. In some embodiments, the hydroxyl functional acrylic resin has a hydroxyl value on solution of about 50 mg KOH/g, about 55 mg KOH/g, about 60 mg KOH/g, about 65 mg KOH/g, about 70 mg KOH/g, about 75 mg KOH/g, about 80 mg KOH/g, about 85 mg KOH/g, about 90 mg KOH/g, about 95 mg KOH/g, about 100 mg KOH/g, about 105 mg KOH/g, about 110 mg KOH/g, about 115 mg KOH/g, or about 120 mg KOH/g.

### C. Color Layers

In some embodiments, such as those generally consistent with the representative cross-sectional views shown in FIGS. 3-4, the film 10 further includes a color layer 300 (e.g., a base layer) disposed between the peelable layer 100 and the topcoat layer 200. Accordingly, embodiments that include this optional color layer 300 provide a convenient and durable opportunity to temporarily (e.g., semi-permanently) change the color(s) of a substrate S, at least because the peelable layer 100 is disposed between the substrate S and the color layer 300. separating the peelable layer 100 from the substrate S also removes the color layer 300 from the substrate S.

In some embodiments, the color layer 300 includes a pigment, such as an auto paint grade pigment. In some embodiments, the color layer 300 comprises a pigment. In some embodiments, the color layer 300 consists essentially of a pigment. In some embodiments, the color layer 300 consists of a pigment.

The color layer 300 may have a thickness t₃₀₀ of about 10 microns to about 200 microns, about 20 microns to about 160 microns, about 30 microns to about 140 microns, or about 40 microns to about 100 microns. In some embodiments, the color layer 300 has a thickness t₃₀₀ of about 10 microns, about 15 microns, about 20 microns, about 25 microns, about 30 microns, about 35 microns, about 40 microns, about 45 microns, about 50 microns, about 55 microns, about 60 microns, about 65 microns, about 70 microns, about 75 microns, about 80 microns, about 85 microns, about 90 microns, about 95 microns, about 100 microns, about 105 microns, about 110 microns, about 115 microns, about 120 microns, about 125 microns, about 130 microns, about 135 microns, about 140 microns, about 145 microns, about 150 microns, about 155 microns, about 160 microns, about 165 microns, about 170 microns, about 175 microns, about 180 microns, about 185 microns, about 190 microns, about 195 microns, or about 200 microns.

In some embodiments, the color layer 300 includes a single layer, such as shown representatively in cross-sectional format in FIG. 3.

In other embodiments, such as those consistent with the cross-sectional views shown in FIG. 4, the color layer 300 includes a plurality of layers 310. In some embodiments, the color layer 300 includes at least two layers 310, such as at least two layers 310, at least 3 layers 310, at least 4 layers 310, at least 5 layers 310, at least 6 layers 310, at least 7 layers 310, at least 8 layers 310, at least 9 layers 310, at least 10 layers 310, or more than 10 layers 310. Each layer 310 may have a thickness t₃₁₀ of about 10 microns to about 50 microns, about 20 microns to about 40 microns, or about 25 microns to about 35 microns. In some embodiments, each layer 310 has a thickness t₃₁₀ of about 10 microns, about 11 microns, about 12 microns, about 13 microns, about 14 microns, about 15 microns, about 16 microns, about 17 microns, about 18 microns, about 19 microns, about 20 microns, about 21 microns, about 22 microns, about 23 microns, about 24 microns, about 25 microns, about 26 microns, about 27 microns, about 28 microns, about 29 microns, about 30 microns, about 31 microns, about 32 microns, about 33 microns, about 34 microns, about 35 microns, about 36 microns, about 37 microns, about 38 microns, about 39 microns, about 40 microns, about 41 microns, about 42 microns, about 43 microns, about 44 microns, about 45 microns, about 46 microns, about 47 microns, about 48 microns, about 49 microns, or about 50 microns.

In some embodiments, a primer layer is disposed between the peelable layer 100 and the color layer 300. In other embodiments, no primer layer is disposed between the peelable layer 100 and the color layer 300.

### Film-Protected Substrates

The present disclosure also provides film-protected substrates 20 that include a film 10 disposed on at least one surface (e.g., on an outer surface, paint layer, or topcoat of the substrate S).

The substrate S may be any surface for which protection might be desired, such as a painted surface like an automobile panel. In some embodiments, the substrate S includes no paint or coating (e.g., topcoat). In other embodiments, the substrate S includes an exposed paint layer or coating, such as a clear coat or other topcoat material.

The peelable layer 100 is disposed on the outermost surface of the substrate S, whether that be the surface of the substrate S itself or a paint or coating layer present on the outermost surface of the substrate S. The topcoat layer 200 is disposed on the peelable layer 100 opposite the substrate S. Optionally (FIGS. 3-4), a color layer 300 (e.g., base coat) is disposed between the peelable layer 100 and the topcoat layer 200.

### Methods of Forming Films

The present disclosure provides methods of forming a film 10 on a substrate S. Generally, the methods comprise a step of applying a peelable layer 100 to the substrate followed by a step of applying a topcoat layer 200. Optionally, the methods further include a step of applying a color layer 300 to the peelable layer 100 before the step of applying the topcoat layer 200.

In some embodiments, the step of applying the peelable layer 100 includes spraying a composition comprising a flexible polymer. The flexible polymer composition may include, in addition to the flexible polymer or its monomeric precursors, a solvent system (i.e., one or more solvents such as heptane, xylene, and/or t-butyl acetate), and/or an antioxidant (e.g., a sterically hindered phenolic oxidant such as pentaerythritol tetrakis(3-(3,5-di-t-butyl4-hydroxyphenyl)propionate)). In some embodiments, the flexible polymer or its monomeric precursors are present in the composition in an amount of about 15% to about 40%, for example about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, or about 40%. In some embodiments, the composition has a viscosity at 25° C. of about 200 cps to about 300 cps, for example about 200 cps, about 205 cps, about 210 cps, about 215 cps, about 220 cps, about 225 cps, about 230 cps, about 235 cps, about 240 cps, about 245 cps, about 250 cps, about 255 cps, about 260 cps, about 265 cps, about 270 cps, about 275 cps, about 280 cps, about 285 cps, about 290 cps, about 295 cps, or about 300 cps.

In some embodiments, the step of spray-applying the peelable layer 100 comprises, consists essentially of, or consists of spraying the flexible polymer composition using a spray gun (e.g., an air-atomized spray gun, an airless spray gun, or a high-volume, low-pressure spray gun) equipped with a spray tip having a nozzle dimension of about 1.6 mm to about 2.0 mm, for example about 1.6 mm, about 1.7 mm, about 1.8 mm, about 1.9 mm, or about 2.0 mm. In some embodiments, the nozzle dimension is about 1.6 mm. In some embodiments, the nozzle dimension is about 1.7 mm. In some embodiments, the nozzle dimension is about 1.8 mm. In some embodiments, the nozzle dimension is about 1.9 mm. In some embodiments, the nozzle dimension is about 2.0 mm.

In some embodiments, the step of applying the peelable layer 100 consists essentially of applying a single layer of the flexible polymer composition to the substrate S. In other embodiments, the step of applying the peelable layer 100 comprises applying a first layer 110 of the flexible polymer composition to the substrate S followed by a step of applying a subsequent layer 110 of the flexible polymer composition to the first applied layer 110 of the flexible polymer composition. The step of applying the subsequent layer 110 of the flexible polymer composition may be repeated until the peelable layer 100 has the desired thickness t₁₀₀.

The final thickness t₁₀₀ of the peelable layer 100 after the step(s) of applying may be about 150 microns to about 300 microns, about 190 microns to about 240 microns, or about 200 microns to about 230 microns. In some embodiments, the final thickness t₁₀₀ of the peelable layer 100 after the step(s) of applying is about 150 microns, about 160 microns, about 170 microns, about 180 microns, about 190 microns, about 200 microns, about 210 microns, about 220 microns, about 230 microns, about 240 microns, about 250 microns, about 260 microns, about 270 microns, about 280 microns, about 290 microns, or about 300 microns. The amount of flexible polymer composition applied to form each layer 110 of the peelable layer 100 may be selected such that each layer 110 has a thickness t₁₁₀ of about 15 microns to about 30 microns, about 19 microns to about 24 microns, or about 20 microns to about 23 microns. In some embodiments, the amount of flexible polymer composition applied to form each layer 110 of the peelable layer 100 is selected such that each layer 110 has a thickness t₁₁₀ of about 15 microns, about 16 microns, about 17 microns, about 18 microns, about 19 microns, about 20 microns, about 21 microns, about 22 microns, about 23 microns, about 24 microns, about 25 microns, about 26 microns, about 27 microns, about 28 microns, about 29 microns, or about 30 microns.

Optionally, the method further comprises applying a color layer 300 (e.g., base coat) to the peelable layer 100. When included, the step of applying the color layer 300 includes spraying a composition comprising a pigment to the peelable layer 100, for example after the peelable layer 100 has substantially cured or fully cured. The pigment composition may include, in addition to the pigment component(s), a solvent or carrier system (i.e., one or more solvents), and/or a binder (e.g., a resin such as a lacquer, an enamel, or a urethane).

In some embodiments, the step of spray-applying the color layer 300 comprises, consists essentially of, or consists of spraying the pigment composition using a spray gun (e.g., an air-atomized spray gun, an airless spray gun, or a high-volume, low-pressure spray gun) equipped with a spray tip having a nozzle dimension of about 1.0 mm to about 2.0 mm, for example about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, or about 2.0 mm. In some embodiments, the nozzle dimension is about 1.0 mm. In some embodiments, the nozzle dimension is about 1.1 mm. In some embodiments, the nozzle dimension is about 1.2 mm. In some embodiments, the nozzle dimension is about 1.3 mm. In some embodiments, the nozzle dimension is about 1.4 mm. In some embodiments, the nozzle dimension is about 1.5 mm. In some embodiments, the nozzle dimension is about 1.6 mm. In some embodiments, the nozzle dimension is about 1.7 mm. In some embodiments, the nozzle dimension is about 1.8 mm. In some embodiments, the nozzle dimension is about 1.9 mm. In some embodiments, the nozzle dimension is about 2.0 mm.

The pigment composition may be applied (e.g., spray-applied) until the color layer 300 has a desired final thickness t₃₀₀ of about 10 microns to about 200 microns, about 20 microns to about 160 microns, about 30 microns to about 140 microns, or about 40 microns to about 100 microns. In some embodiments, pigment composition may be applied (e.g., spray-applied) until the color layer 300 has a thickness t₃₀₀ of about 10 microns, about 15 microns, about 20 microns, about 25 microns, about 30 microns, about 35 microns, about 40 microns, about 45 microns, about 50 microns, about 55 microns, about 60 microns, about 65 microns, about 70 microns, about 75 microns, about 80 microns, about 85 microns, about 90 microns, about 95 microns, about 100 microns, about 105 microns, about 110 microns, about 115 microns, about 120 microns, about 125 microns, about 130 microns, about 135 microns, about 140 microns, about 145 microns, about 150 microns, about 155 microns, about 160 microns, about 165 microns, about 170 microns, about 175 microns, about 180 microns, about 185 microns, about 190 microns, about 195 microns, or about 200 microns.

In some embodiments, the step of applying the color layer 300 consists essentially of applying a single layer of the pigment composition to the peelable layer 100. In other embodiments, such as those consistent with the cross-sectional views shown in FIG. 4, step of applying the color layer 300 comprises applying a first layer 310 of the pigment composition to the peelable layer 100 followed by a step of applying a subsequent layer 310 of the pigment composition to the first applied layer 310 of the pigment composition. The step of applying the subsequent layer 310 of the pigment composition may be repeated until the color layer 300 has the desired thickness t₃₀₀.

The amount of pigment composition applied to form each layer 310 of the color layer 300 may be selected such that each layer 310 has a thickness t₃₁₀ of about 10 microns to about 50 microns, about 20 microns to about 40 microns, or about 25 microns to about 35 microns. In some embodiments, the amount of pigment composition applied to form each layer 310 of the color layer 300 is selected such that each layer 310 has a thickness t₃₁₀ of about 10 microns, about 11 microns, about 12 microns, about 13 microns, about 14 microns, about 15 microns, about 16 microns, about 17 microns, about 18 microns, about 19 microns, about 20 microns, about 21 microns, about 22 microns, about 23 microns, about 24 microns, about 25 microns, about 26 microns, about 27 microns, about 28 microns, about 29 microns, about 30 microns, about 31 microns, about 32 microns, about 33 microns, about 34 microns, about 35 microns, about 36 microns, about 37 microns, about 38 microns, about 39 microns, about 40 microns, about 41 microns, about 42 microns, about 43 microns, about 44 microns, about 45 microns, about 46 microns, about 47 microns, about 48 microns, about 49 microns, or about 50 microns.

In some embodiments, the method further comprises applying (e.g., spray-applying) a primer layer on the peelable layer 100 before the step of applying (e.g., spray-applying) the color layer 300. In other embodiments, the method does not include a step of applying a primer layer on the peelable layer 100 before the step of applying (e.g., spray-applying) the color layer 300.

Methods consistent with the present disclosure further comprise a step of applying a topcoat layer 200 to the color layer 300 (when present) or to the peelable layer 100 (when the color layer 300 is not present).

In some embodiments, the step of applying the topcoat layer 200 includes spraying a composition comprising a self-healing polymer (e.g., an autonomously self-healing polymer) or its monomeric precursor(s). The self-healing polymer composition may include, in addition to the self-healing polymer or its monomeric precursor(s), a solvent system (i.e., one or more solvents such as methoxypropyl acetate). In some embodiments, the self-healing polymer has a Gardner viscosity at 25° C. of G to L (e.g., about 160 cps to about 300 cps, such as about 160 cps, about 165 cps, about 170 cps, about 175 cps, about 180 cps, about 185 cps, about 190 cps, about 195 cps, about cps, about 200 cps to about 300 cps, for example about 200 cps, about 205 cps, about 210 cps, about 215 cps, about 220 cps, about 225 cps, about 230 cps, about 235 cps, about 240 cps, about 245 cps, about 250 cps, about 255 cps, about 260 cps, about 265 cps, about 270 cps, about 275 cps, about 280 cps, about 285 cps, about 290 cps, about 295 cps, or about 300 cps).

In some embodiments, the step of spray-applying the topcoat layer 200 comprises, consists essentially of, or consists of spraying the self-healing polymer composition using a spray gun (e.g., an air-atomized spray gun, an airless spray gun, or a high-volume, low-pressure spray gun) equipped with a spray tip having a nozzle dimension of about 1.0 mm to about 2.0 mm, for example about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, or about 2.0 mm. In some embodiments, the nozzle dimension is about 1.0 mm. In some embodiments, the nozzle dimension is about 1.1 mm. In some embodiments, the nozzle dimension is about 1.2 mm. In some embodiments, the nozzle dimension is about 1.3 mm. In some embodiments, the nozzle dimension is about 1.4 mm. In some embodiments, the nozzle dimension is about 1.5 mm. In some embodiments, the nozzle dimension is about 1.6 mm. In some embodiments, the nozzle dimension is about 1.7 mm. In some embodiments, the nozzle dimension is about 1.8 mm. In some embodiments, the nozzle dimension is about 1.9 mm. In some embodiments, the nozzle dimension is about 2.0 mm.

In some embodiments, the step of applying the topcoat layer 200 consists essentially of applying a single layer of the self-healing polymer composition to the color layer 300 (when present) or to the peelable layer 100. In other embodiments, the step of applying the topcoat layer 200 comprises applying a first layer 210 of the self-healing polymer composition to the color layer 300 or to the peelable layer 100, followed by a step of applying a subsequent layer 210 of the self-healing polymer composition to the first applied layer 210 of the self-healing polymer composition. The step of applying the subsequent layer 210 of the self-healing polymer composition may be repeated until the topcoat layer 100 has the desired thickness t₂₀₀.

The final thickness t₂₀₀ of the topcoat layer 200 after the step(s) of applying may be about 40 microns to about 120 microns, about 50 microns to about 100 microns, or about 60 microns to about 80 microns. In some embodiments, the final thickness t₂₀₀ of the topcoat layer 200 after the step(s) of applying is about 40 microns, about 50 microns, about 60 microns, about 70 microns, about 80 microns, about 90 microns, about 100 microns, about 110 microns, about 120 microns, about 130 microns, about 140 microns, about 150 microns, about 160 microns, about 170 microns, about 180 microns, about 190 microns, or about 200 microns. The amount of self-healing polymer composition applied to form each layer 210 of the topcoat layer 200 may be selected such that each layer 210 has a thickness t₂₁₀ of about 8 microns to about 30 microns, about 10 microns to about 25 microns, or about 12 microns to about 20 microns. In some embodiments, the amount of self-healing polymer composition applied to form each layer 210 of the topcoat layer 200 is selected such that each layer 210 has a thickness t₂₁₀ of about 8 microns, about 9 microns, about 10 microns, about 11 microns, about 12 microns, about 13 microns, about 14 microns, about 15 microns, about 16 microns, about 17 microns, about 18 microns, about 19 microns, about 20 microns, about 21 microns, about 22 microns, about 23 microns, about 24 microns, about 25 microns, about 26 microns, about 27 microns, about 28 microns, about 29 microns, or about 30 microns.

### EXAMPLE

A film 10 consistent with the present disclosure was prepared by spray-applying 10 layers 110 of a flexible polymer composition comprising Kraton G1643MS styrene ethylene/butylene linear triblock copolymer to a painted automobile panel (substrate S) to form a peelable layer 100. After the peelable layer 100 fully cured, a color layer 300 comprising a yellow pigment was spray-applied in 3 layers 310 to the peelable layer 100. No primer was applied to the peelable layer 100 before the color layer 300 was applied. After the color layer 300 fully cured, 4 layers 210 of an autonomously self-healing polymer composition comprising a hydroxyl functional acrylic resin were spray-applied to the color layer 300. Once cured, the film 10 had a total thickness (t₁₀₀ + t₂₀₀ + t₃₀₀) of about 280-290 microns.

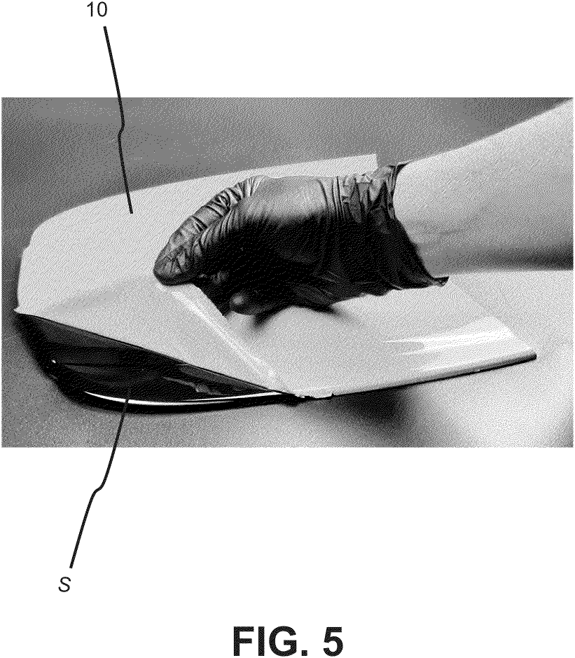

FIG. 5 shows the film 10 being peeled away from the substrate S.

### FURTHER EXAMPLES

Further Example 1. A protective film comprising:
a first layer disposed adjacent to a painted surface, the first layer comprising, consisting essentially of, or consisting of a flexible polymer; and
an outer layer disposed opposite the painted surface, the top layer comprising, consisting essentially of, or consisting of a topcoat material.

Further Example 2. The protective film of Further Example 1, wherein the flexible polymer comprises, consists essentially of, or consists of a copolymer.

Further Example 3. The protective film of Further Example 2, wherein the copolymer comprises, consists essentially of, or consists of a linear triblock copolymer of styrene and ethylene/butylene.

Further Example 4. The protective film of Further Example 3, wherein the linear triblock copolymer includes a polystyrene content of about 10% to about 30%.

Further Example 5. The protective film of any one of Further Examples 1-4, wherein the outer layer is a self-healing topcoat layer.

Further Example 6. The protective film of Further Example 5, wherein the self-healing topcoat layer comprises, consists essentially of, or consists of a hydroxyl functional acrylic resin.

Further Example 7. The protective film of Further Example 6, wherein the hydroxyl functional acrylic resin has an OH value on solution of about 80 to about 90 mg KOH/g.

Further Example 8. The protective film of any one of Further Examples 5-7, wherein the self-healing topcoat layer is capable of healing (e.g., reversing) marring or scratches without application of energy (e.g., heat).

Further Example 9. The protective film of any one preceding Further Example, wherein the first layer has a thickness of about 190 microns to about 240 microns.

Further Example 10. The protective film of any one preceding Further Example, wherein the outer layer has a thickness of about 50 microns to about 100 microns.

Further Example 11. The protective film of any one preceding Further Example further comprising a color layer (e.g., base coat) disposed between the first layer and the outer layer.

Further Example 12. A spray-applied protective film product comprising:
a spray-applied base layer component comprising, consisting essentially of, or consisting of a peelable polymer; and
a spray-applied outer layer component comprising, consisting essentially of, or consisting of a self-healing polymer.

Further Example 13. The spray-applied protective film of Further Example 12, wherein the peelable polymer comprises, consists essentially of, or consists of a copolymer.

Further Example 14. The spray-applied protective film of Further Example 13, wherein the copolymer comprises, consists essentially of, or consists of a linear triblock copolymer of styrene and ethylene/butylene.

Further Example 15. The spray-applied protective film of Further Example 14, wherein the linear triblock copolymer includes a polystyrene content of about 10% to about 30%.

Further Example 16. The spray-applied protective film of any one of Further Examples 12-15, wherein the spray-applied outer layer is a self-healing topcoat layer.

Further Example 17. The spray-applied protective film of Further Example 16, wherein the self-healing topcoat layer comprises, consists essentially of, or consists of a hydroxyl functional acrylic resin.

Further Example 18. The spray-applied protective film of Further Example 17, wherein the hydroxyl functional acrylic resin has an OH value on solution of about 80 to about 90 mg KOH/g.

Further Example 19. The spray-applied protective film of any one of Further Examples 16-18, wherein the self-healing topcoat layer is configured to heal (e.g., reverse) marring or scratching without substantial application of energy (e.g., heat).

Further Example 20. The spray-applied protective film of any one of Further Examples 12-19, wherein the spray-applied first layer has a thickness of about 190 microns to about 240 microns.

Further Example 21. The spray-applied protective film of any one of Further Examples 12-20, wherein the spray-applied outer layer has a thickness of about 50 microns to about 100 microns.

Further Example 22. The spray-applied protective film of any one of Further Examples 12-21 further comprising a color layer (e.g., base coat) disposed between the spray-applied base layer and the spray-applied outer layer.

Further Example 23. A method of forming a paint protective layer on a substrate, the method comprising:
applying a first layer to the substrate, the first layer comprising, consisting essentially of, or consisting of a peelable polymer; and
applying an outer layer to the first layer, the outer layer component comprising, consisting essentially of, or consisting of a self-healing polymer.

Further Example 24. The method of Further Example 23, wherein the peelable polymer comprises, consists essentially of, or consists of a copolymer.

Further Example 25. The method of Further Example 24, wherein the copolymer comprises, consists essentially of, or consists of a linear triblock copolymer of styrene and ethylene/butylene.

Further Example 26. The method of Further Example 25, wherein the linear triblock copolymer includes a polystyrene content of about 10% to about 30%.

Further Example 27. The method of any one of Further Examples 23-26, wherein the outer layer is a self-healing topcoat layer.

Further Example 28. The method of Further Example 27, wherein the self-healing topcoat layer comprises, consists essentially of, or consists of a hydroxyl functional acrylic resin.

Further Example 29. The method of Further Example 28, wherein the hydroxyl functional acrylic resin has an OH value on solution of about 80 to about 90 mg KOH/g.

Further Example 30. The method of any one of Further Examples 27-29, wherein the self-healing topcoat layer is capable of healing (e.g., reversing) marring or scratching without substantial application of energy (e.g., heat).

Further Example 31. The method of any one of Further Examples 23-30, wherein the step of applying the first layer comprises applying a plurality of layers of the peelable polymer.

Further Example 32. The method of Further Example 31, wherein the step of applying the first layer comprises applying a plurality of layers of the peelable polymer until the first layer has a thickness of about 190 microns to about 240 microns.

Further Example 33. The method of any one of Further Examples 23-32, wherein the step of applying the first layer comprises spraying a composition comprising the peelable polymer.

Further Example 34. The method of any one of Further Examples 23-33, wherein the step of applying the outer layer comprises applying a plurality of layers of the self-healing polymer.

Further Example 35. The method of Further Example 34, wherein the step of applying the outer layer comprises applying a plurality of layers of the self-healing polymer until the outer layer has a thickness of about 50 microns to about 100 microns.

Further Example 36. The method of any one of Further Examples 23-35, wherein the step of applying the outer layer comprises spraying a composition comprising the self-healing polymer.

Further Example 37. The method of any one of Further Examples 23-36 further comprising applying a color layer (e.g., base coat) on the first layer before the step of applying the outer layer.

Further Example 38. The method of Further Example 37, wherein the step of applying the color layer comprises spraying a composition comprising a pigment.

Further Example 39. A film-protected substrate comprising:
a pre-existing paint layer adhered to a surface of a substrate;
a first layer disposed adjacent to a painted surface, the first layer comprising, consisting essentially of, or consisting of a flexible polymer; and
an outer layer disposed opposite the painted surface, the top layer comprising, consisting essentially of, or consisting of a topcoat material.

Further Example 40. The film-protected substrate of Further Example 39, wherein the flexible polymer comprises, consists essentially of, or consists of a copolymer.

Further Example 41. The film-protected substrate of Further Example 40, wherein the copolymer comprises, consists essentially of, or consists of a linear triblock copolymer of styrene and ethylene/butylene.

Further Example 42. The film-protected substrate of Further Example 41, wherein the linear triblock copolymer includes a polystyrene content of about 10% to about 30%.

Further Example 43. The film-protected substrate of any one of Further Examples 39-42, wherein the outer layer is a self-healing topcoat layer.

Further Example 44. The film-protected substrate of Further Example 43, wherein the self-healing topcoat layer comprises, consists essentially of, or consists of a hydroxyl functional acrylic resin.

Further Example 45. The film-protected substrate of Further Example 44, wherein the hydroxyl functional acrylic resin has an OH value on solution of about 80 to about 90 mg KOH/g.

Further Example 46. The film-protected substrate of any one of Further Examples 43-45, wherein the self-healing layer is capable of healing (e.g., reversing) marring or scratching without substantial application of energy (e.g., heat).

Further Example 47. The film-protected substrate of any one of Further Examples 39-46, wherein the first layer has a thickness of about 190 microns to about 240 microns.

Further Example 48. The film-protected substrate of any one of Further Examples 39-47, wherein the outer layer has a thickness of about 50 microns to about 100 microns.

Further Example 49. The film-protected substrate of any one of Further Examples 39-48 further comprising a color layer (e.g., base coat) disposed between the first layer and the outer layer.

What is claimed is:

1. A protective film comprising:
a first layer disposed adjacent to a painted surface, the first layer comprising, consisting essentially of, or consisting of a flexible polymer; and
an outer layer disposed opposite the painted surface, the top layer comprising, consisting essentially of, or consisting of a topcoat material.

2. The protective film of claim 1, wherein the flexible polymer comprises, consists essentially of, or consists of a copolymer.

3. The protective film of claim 2, wherein the copolymer comprises, consists essentially of, or consists of a linear triblock copolymer of styrene and ethylene/butylene.

4. The protective film of claim 3, wherein the linear triblock copolymer includes a polystyrene content of about 10% to about 30%.

5. The protective film of claim 1, wherein the outer layer is a self-healing topcoat layer.

6. The protective film of claim 5, wherein the self-healing topcoat layer comprises, consists essentially of, or consists of a hydroxyl functional acrylic resin.

7. The protective film of claim 6, wherein the hydroxyl functional acrylic resin has an OH value on solution of about 80 to about 90 mg KOH/g.

8. The protective film of claim 5, wherein the self-healing topcoat layer is capable of healing (e.g., reversing) marring or scratches without application of energy (e.g., heat).

9. The protective film of claim 1, wherein the first layer has a thickness of about 190 microns to about 240 microns, or a thickness of about 50 microns to about 100 microns.

10. The protective film of claim 1 further comprising a color layer (e.g., base coat) disposed between the first layer and the outer layer.

11. A spray-applied protective film product comprising:
a spray-applied base layer component comprising, consisting essentially of, or consisting of a peelable polymer; and
a spray-applied outer layer component comprising, consisting essentially of, or consisting of a self-healing polymer.

12. The spray-applied protective film of claim 11, wherein the peelable polymer comprises, consists essentially of, or consists of a copolymer.

13. The spray-applied protective film of claim 12, wherein the copolymer comprises, consists essentially of, or consists of a linear triblock copolymer of styrene and ethylene/butylene.

14. The spray-applied protective film of claim 13, wherein the linear triblock copolymer includes a polystyrene content of about 10% to about 30%.

15. The spray-applied protective film of claim 11, wherein the spray-applied outer layer is a self-healing topcoat layer.

16. The spray-applied protective film of claim 15, wherein the self-healing topcoat layer comprises, consists essentially of, or consists of a hydroxyl functional acrylic resin.

17. The spray-applied protective film of claim 16, wherein the hydroxyl functional acrylic resin has an OH value on solution of about 80 to about 90 mg KOH/g.

18. The spray-applied protective film of claim 15, wherein the self-healing topcoat layer is configured to heal (e.g., reverse) marring or scratching without substantial application of energy (e.g., heat).

19. The spray-applied protective film of claim 11, wherein the spray-applied first layer has a thickness of about 190 microns to about 240 microns, or a thickness of about 50 microns to about 100 microns.

20. The spray-applied protective film of claim 11 further comprising a color layer (e.g., base coat) disposed between the spray-applied base layer and the spray-applied outer layer.
